(19) United States
(12) Patent Application Publication
(10) Pub. No.: US 2006/0194154 A1
(43) Pub. Date: Aug. 31, 2006

(54) Developer composition

(75) Inventors: Chi-Sheng Chen, Sanchung City (TW); Hung-Jen Liu, Danshui Town (TW); Meng-Hsun Cheng, Chang-Li City (TW)

Correspondence Address: BACON & THOMAS, PLLC, 625 SLATERS LANE, FOURTH FLOOR, ALEXANDRIA, VA, 22314, US

(73) Assignee: Everlight USA, Inc., Pineville, NC (US)

(21) Appl. No.: 11/196,473

(22) Filed: Aug. 4, 2005

(30) Foreign Application Priority Data
Feb. 28, 2005 (CN) 200510052183. 2

(51) Int. Cl. G03C 5/00

(52) U.S. Cl. 430/331

(57) ABSTRACT

The present invention relates to a developer composition comprising: (a) alkali metal carbonate salt; (b) alkali metal bicarbonate salt; (c) nonionic surfactant of formula (I) below 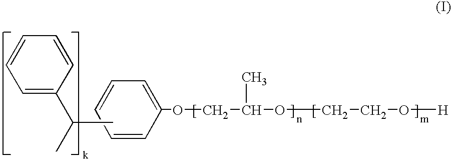
wherein, k, n and m are defined as in the description; and (d) nonionic surfactant of formula (II) below 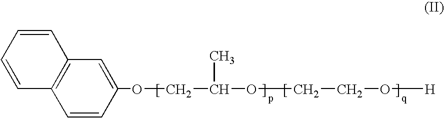 wherein, p and q are defined as in the description; wherein with respect to 100 parts by weight of water, the aforementioned component (a) is 0.1˜10 parts by weight, the aforementioned component (b) is 0.1˜10 parts by weight, the aforementioned component (c) is 0.1˜20 parts by weight, and the aforementioned component (d) is 0.1˜20 parts by weight. The present invention also relates to a developer.

### BACKGROUND OF THE INVENTION

1. Field of the Invention

The present invention relates to a developer composition of photoresist, particularly it is used in the fabrication of integrated circuits, print circuit boards, and liquid crystal displays, where the photoresist and other radiation sensitive resin film are exposed by radiation and then developed to remove unwanted coatings for superb pattern.

2. Description of the Related Prior Art

Fabrication of the integrated circuits, print circuit boards, and liquid crystal displays with subtle pattern often involve coating a film of photoresist or a film of radiation sensitive resin composition on an article to be processed, and then exposed under radiation, thereafter with an alkali developer the article is developed to remove unwanted coatings for superb pattern.

Typical used methods for developing including immersion development, shaking development, spraying development and puddle development. Generally the photoresist is prepared by using alkali-soluble resins such as novolac, acrylic polymers, and poly para-hydroxy styrene with different radiation sensitive matters to obtain a positive or a negative photoresist, and by radiating, the solubility varies and allows the photoresist to be dissolved in the alkali developer. Generally sodium hydroxide, potassium hydroxide, sodium carbonate, sodium bicarbonate, tetra-methyl ammonium hydroxide or alkanolamine etc are widely used for.

Base on the conventional developing skills, after the photoresist is coated, heated and exposed, an alkaline developer is dissolved with to remove the unwanted unexposed coated region film, the acidic functional groups of the photoresist are responsible for the developed shadows. The acid group of the organic polymer will be neutralized in an alkaline solution to form a water soluble organic polymeric salt. When the dissolving photoresist accumulates in the solution, insoluble organic materials start to form in the development tank, and water insoluble residues and scum are obtained lastly. During the developing process, these sediments increase the likelihood for undeveloped partial particles or insoluble residues to form and result in imprecise photoresist pattern. To improve the flaws of the aforementioned, surfactants are added to reduce the likelihood for scum formations. As the Japanese Patent application Laid-open No. 7-120935 and Laid-open No. 9-34128 already disclosed, where phenol or nonylphenol of the ethylene oxide nonionic surfactants have the capability of reducing scum. Furthermore, other benefits from adding surfactants including enhancing the adjust development efficiency and increasing the production throughput.

And, general basic compounds such as sodium hydroxide, potassium hydroxide, carbonate, bicarbonate, tetra-methyl ammonium hydroxide or alkanolamine, the aforementioned alkaline developer is able to absorb atmospheric carbon dioxide gas and from that it degrades, also during the developing process the alkaline components are likely to react with the acidic functional groups, and resulting the pH of the developer changes dramatically in the developing process and affects the process stability. Therefore, in the Japanese Patent application Laid-open No. 5-88377 or Laid-open No.10-213908 the use of general alkaline matter and its conjugated acid-base pair for allowing alkaline developer to have the pH buffer capability as well as reducing the changes of parameters in the developing process is disclosed.

However, the aforementioned alkaline matter and its conjugated acid-base pair or the aforementioned method of nonionic surfactants can not satisfy the stability and resolution of the developer.

### SUMMARY OF THE INVENTION

The present invention provides a developer composition and a developer. The use of the developer on the photoresist pattern obtained from the exposure or on the color filter, the unwanted coated film is dissolved, while scum, surface contaminants, film residues and others are not produced, thereby a developer for the use of photoresist composition that allows clear defined pattern of photoresist pattern or color filter is obtained.

With respect to 100 parts by weight of water, the developer composition of the present invention comprising (a) 0.1 to 10% weight percent of alkali metal carbonate salt; (b) 0.1 to 10% weight percent of alkali metal bicarbonate salt; (c) 0.1 to 20% weight percent of the following nonionic surfactant of formula (I): 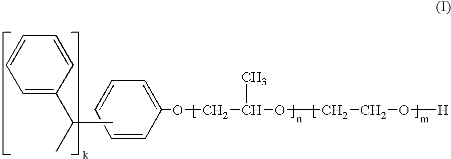
wherein
K is an integer of 1 to 3; n is an integer of 0 to 10; m is an integer of 4 to 20; and (d) 0.1 to 20% weight percent of the following nonionic surfactant of formula (II): 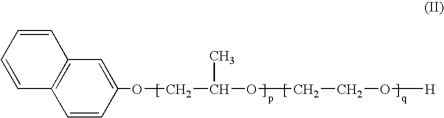
wherein
p is an integer of 0 to 10; q is an integer of 4 to 20.

The developer composition of the present invention, n of formula (I) preferably is 0, 1, 2, 3, 4, or 5. m of formula (I) preferably is an integer of 6 to 15. p of formula (II) preferably is 0, 1, 2, 3, 4, or 5. Preferably q is an integer of 6 to 15.

Using the nonionic surfactant of formula (I) independently with the developer prepared from the alkali metal carbonate salt and alkali metal bicarbonate salt, it is apparent that the developing rate is slower than that of developer having oxyethylene nonylphenyl ether, also the concentration of the nonionic surfactant of formula (I) in the developer increases without apparent increase of the developing rate; if using the nonionic surfactant of formula (II) with the developer, the developing rate is too rapid where the photoresist pattern tend to strip off and resulting in a narrow process window that increases the production difficulty.

The present invention utilizes both nonionic surfactants of formula (I) and (II) with the developer prepared from the alkali metal carbonate salt and alkali metal bicarbonate salt. By mixing together the two surfactants, developer with satisfying developing rate and process window is obtained.

Examples of the alkali metal carbonate salt of the developer composition of the present invention are sodium carbonate, or potassium carbonate. Examples of the alkali metal bicarbonate salt are sodium bicarbonate, or potassium bicarbonate. It is not restricted to directly prepare with the use of alkali metal carbonate salt and alkali metal bicarbonate salt together or other similar methods. Examples of buffer solutions having similar effects are the preparation of alkali metal carbonate salt with muriatic acid or the preparation of alkali metal bicarbonate salt with sodium hydroxide.

The developer composition of the present invention is suitable for use with photoresists comprising colorants or a photoresist composition comprising an acrylic polymers applied to a photoresist consisting of colorants.

The nonionic surfactants of formula (I) and (II) of the developer composition of the present invention, wherein respectively m and q are an integer of 4 to 20, wherein preferably are an integer of 6 to 15. When m or q is less than 4 the solubility is insufficient causing the unwanted photoresist to remain; when m or q is greater than 20 slight amounts of surfactants remain on the photoresist film and decrease the physical properties of the obtained developed film.

With respect to 100 parts by weight of water, the amount of nonionic surfactants of formula (I) and (II) are preferably 0.01 to 25 parts by weight, and more preferably 0.1 to 20 parts by weight. When the amount used is less than 0.01 parts by weight, the effect is insufficient and more susceptible to the formation of residual film; when the said amount exceeds 25 parts by weight, solubility of the alkaline matter tends to decrease and serious foaming and other problems are subjected.

The developer composition of the present invention comprising (a) alkali metal carbonate salt, (b) alkali metal bicarbonate salt, (c) nonionic surfactant of the general formula (I) below, and (d) nonionic surfactant of the general formula (II) below, the above are the necessary components, while the remaining components are the same as any typical photoresist developer. Therefore, the developer of the present invention consisting of specific alkaline components, specific nonionic surfactants and basic aqueous solution, the pH is preferably adjusted to 9-13, and more preferably 10-12. When the said pH is less than 9, under a low alkalinity there is a higher tendency for the formation of residual film, while the pH is exceeded 13, under a high alkalinity the photoresist film tends to fall or strip off.

With respect to 100 parts by weight of water, the amount of alkali metal carbonate salt and alkali metal bicarbonate salt used are preferably 0.01 to 20 parts by weight, and more preferably 0.1 to 10 parts by weight, the pH of the obtained developer is selected in the range of 9 to 13. With respect to 100 part by weight of water, the amount of nonionic surfactant of formula (I) used is preferably 0.01 to 20 parts by weight, and more preferably 0.1 to 10 parts by weight. When the amount used is less than 0.01 parts by weight, the effect is insufficient and more susceptible to the formation of residual film; when the said amount exceeds 20 parts by weight, solubility of the alkaline matter tends to decrease and serious foaming and other problems are subjected.

For adjusting the best pH or other physical properties, the developer composition of the present invention is further added with other known alkaline compounds such as lithium, potassium, sodium, and other alkali metal hydroxides, bicarbonate, phosphate, borate, or ammonia and other inorganic alkaline compounds; tetramethylammonium hydroxide, 2-hydroxyethyl-N,N,N-trimethyl ammonium hydroxide, monomethyl amine, dimethylamine, trimethylamine, monoethyl amine, diethylamine, triethylamine, monoisopropyl amine, diisopropylamine, triisopropylamine, monoethanol amine, diethanolamine, triethanolamine, monoethanol dimethylamine, and other organic alkaline compounds.

The developer composition of the present invention, if necessary, surfactants such as other nonionic surfactants, anionic surfactants, cationic surfactants, amphoteric surfactants and polymeric surfactant may be further added to. With the use of these surfactants the solubility and dispersion of the alkaline compounds are enhanced, as well the developing sensitivity can be adjusted.

Examples of the aforementioned nonionic surfactant are polyoxyethylene alkyl ether, polyoxyethylene alkylphenyl ether, polyoxyethylene fatty acid ester, sorbitan fatty acid ester, polyoxyethylene sorbitan fatty acid ester, polyoxyethylene polyoxypropylene ether or condensation of polyoxyethylene fatty acid amide, amide and/or acid.

Examples of the aforementioned cationic surfactant are alkly dimethyl benzyl quaternary ammonium salt, alkyl trimethyl quaternary ammonium salt, dialkyl dimethyl quaternary ammonium salt, or picoline quaternary ammonium salt.

Examples of the aforementioned anionic surfactant are sodium lauryl sulfate, triethanolamine lauryl sulfate, dodecyl sodium polyoxyethylene ether sulphate, ammonium lauryl sulfate, dodecyl ammonium polyoxyethylene ether sulphate, alkyl benzene sulfonic acid or sodium dodecyl benzenesulfonate.

Examples of the aforementioned polymeric surfactant are polyvinyl alcohol, poly (methyl)sodium acrylate, potassium poly(meth)acrylate, ammonium poly(meth)acrylate, poly(meth)acrylate acetate, and other monomers or copolymer of other monomers or crosslinked polymer.

For enhancing the solubility of alkaline compound in water or adjusting the developing efficiency, good water soluble organic solvents may be added as co-solvents, examples of are ethanol, isopropyl alcohol, butanol, hexanol, cyclohexanol, octanol, iso-nonanol, ethanediol, glycerol and other alcohols; ethylene glycol monoalkyl ether; dihylene glycol monoalkyl ether; dihylene glycol dialkyl ether; polypropylene glycol monoalkyl ether acetate etc.

For transportation convenience, the developer composition of the present invention can be used directly or used as a concentrate that requires to be diluted with 10 or 20 times by weight of ultra pure water, wherein it is preferable for concentrate to be diluted with 10 times by weight of ultra pure water.

The developer of the present invention is suitable for the use with photosensitive resin having a colorant, the aforementioned photosensitive resin is not critical and may be positive or negative photosensitive resin composition, color photosensitive resin composition is restricted where often it comprises of organic or inorganic colorants, alkaline soluble binder resin, and photosensitive compounds/solvents and others; examples of the aforementioned alkaline soluble binder resin are novolac resin, acrylate resin, maleic anhydride or polymeric half ester of it, polydydroxy styrene and others, wherein acrylate resin is preferred. Other possible examples are: methyl (meth)acrylate/hydroxyl phenol/styrene/(meth)acrylic acid polymer, benzyl methacrylate/(meth)acrylic acid/styrene polymer, methyl (meth)acrylate/(meth)acrylic acid/polystyrene, methyl (meth)acrylate/benzyl (meth)acrylate/(meth)acrylic acid polymer.

Wherein molecular weight is ranging from 5000˜200000, and more preferably 15000-60000.

### DETAILED DESCRIPTION OF THE PREFERRED EMBODIEMENTS

The present invention is described in detail with the following specific examples:

The following examples provide the present invention with concrete explanation of the procedures. It is to be understood that many other possible modifications and variations can be made without departing from the spirit and scope of the invention hereinafter claimed. Quantities are given in weight if there is no indication.

The developer composition of the present invention is used on the patterned material obtained by exposing the colored photoresist; the components of the colored photoresist composition and the amount of the colored photoresist composition used are shown in the following table:

TABLE 1
Components of the colored photoresist composition

| | | Amount |
|---|---|---|
| | Concrete examples | used |
| Components | of the components | (gram) |
| Binder resin | Methylacrylic acid/Methyl acrylate/benzyl | 4.00 |
| | methacrylate polymer (25:25:50, GPC detects | |
| | an average molecular weight of 30,000) | |
| Multifunctional | Aronix M-400 (Product of Toagosei Co., | 1.20 |
| monomer | Ltd.) | |
| Photo initiator | IRGACURE 369 (Product of Ciba Specialty | 0.30 |
| | Chemicals) | |
| | Chemcure-ITX (Product of Chembridge | 0.08 |
| | International Corp) | |
| Organic solvent | (Propyleneglycol methyl etheracetate; | 9.54 |
| | PGMEA) | |
| Dye | C.I. Red Pigment 177/C.I. Red Pigment 254 | 4.00 |
| | (Products of Dai Nippon Ink) | |

Preparation of the Colored Photoresist

The colored photoresist is spin-coated on top of a glass substrate, inside a clean oven setting at 90° C. the glass substrate is heated for 10 minutes. After, the substrate is then cooled to room temperature, and with a high pressure mercury vapor lamp, through a line width of 90 μm photo mask, to the photoresist film, an energy of 120 mJ/cm² is exposed on top of.

Developing the Colored Photoresist

Surfactants selected and used in the examples are:
Surfactant A (Polyoxyethylene Distyrenated Phenyl Ether), 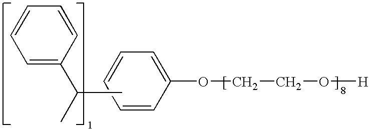
Surfactant B (Polyoxyethylene Distyrenated Phenyl Ether), 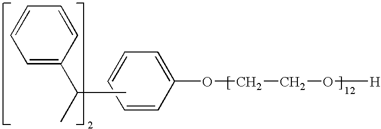
Surfactant C (Polyoxyethylene Tristyrenated Phenyl Ether), 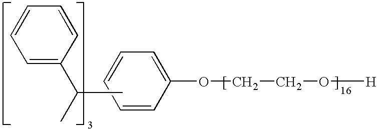
Surfactant D (Polyoxyethylene β-Naphtyl Ether), 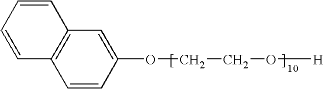
Surfactant E (Polyoxyethylene β-Naphtyl Ether), and 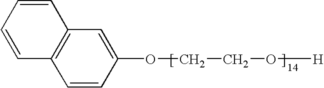
Surfactant F (Polyoxyethylene Nonyl Phenyl Ether).

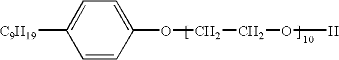

The developers of table 2 are based on parts by weight, where alkaline compounds and nonionic surfactants are further added and mixed with 100 parts by weight of ultra pure water to prepare an aqueous solution.

TABLE 2
Preparation of the developer composition concentrate

| | | | Amount of surfactants added | | | | | |
|---|---|---|---|---|---|---|---|---|
| | Na₂CO₃ | NaHCO₃ | A | B | C | D | E | F |
| Example 1 | 1.6 | 0.6 | 3.5 | | | | 1.0 | |
| Example 2 | 1.6 | 0.6 | | 3.0 | | 1.8 | | |
| Example 3 | 1.6 | 0.6 | | 3.0 | | | 1.8 | |
| Example 4 | 1.6 | 0.6 | | | 3.0 | 2.0 | | |
| Comparative | 1.6 | 0.6 | | 4.0 | | | | |
| Example 1 | | | | | | | | |
| Comparative | 1.6 | 0.6 | | 6 | | | | |
| Example 2 | | | | | | | | |
| Comparative | 1.6 | 0.6 | | | 4.0 | | | |
| Example 3 | | | | | | | | |
| Comparative | 1.6 | 0.6 | | | | 4.0 | | |
| Example 4 | | | | | | | | |
| Comparative | 1.6 | 0.6 | | | | | 4.0 | |
| Example 5 | | | | | | | | |
| Comparative | 1.6 | 0.6 | | | | | | 4.0 |
| Example 6 | | | | | | | | |

The afore prepared developer composition concentrate of table 2 is diluted with ultra pure water for an aqueous solution having 10 time the weight of the concentrate to obtain the developer. After, the substrate is immersed in the aforementioned developer under 23° C., at different times it is agitated and immersed for development. Followed with the development, ultra pure water is washed with, and dried after with nitrogen gas. The dried pattern is further proceeded with post-exposure hard bake in an oven at 220° C. for 40 minutes.

Methods for Assessing the Developer

1, Development:

Under the Scanning Electron Microscope (SEM), the pattern on the glass substrate is examined for defects; and determined for residual film in the unexposed region.
◯: formed pattern has no defects or no visible residual films are detected in the unexposed region.
X: formed pattern has defects or unexposed region has residual films.
   2, Defoam:

To 100 ml graduated cylinder, 20 ml of the prepared developer is added and vertically shacked aggressively after, then it is stand still for 10 minutes where the height of the foam is measured after. With respect to the height of the foam, the following are the standards used for assessment.
◯: Under 10 mm.
X: Above 10 mm.

The hard baked photoresist film, under a microscope the pattern on the glass substrate is then examined for defects; and determined for residual film in the unexposed region, the results obtained are as follow:

TABLE 3
Assessment of the developers

| | | Development (Developing time in seconds) | | | | | | | | | | | | | |
|---|---|---|---|---|---|---|---|---|---|---|---|---|---|---|---|
| | Defoam | 20 | 30 | 40 | 50 | 60 | 70 | 80 | 90 | 100 | 110 | 120 | 140 | 180 | 200 |
| Example 1 | ◯ | X | X | X | ◯ | ◯ | ◯ | ◯ | ◯ | ◯ | ◯ | ◯ | X | X | X |
| Example 2 | ◯ | X | X | X | X | ◯ | ◯ | ◯ | ◯ | ◯ | ◯ | ◯ | X | X | X |
| Example 3 | ◯ | X | X | X | X | X | ◯ | ◯ | ◯ | ◯ | ◯ | ◯ | ◯ | X | X |
| Example 4 | ◯ | X | X | X | X | X | ◯ | ◯ | ◯ | ◯ | ◯ | ◯ | X | X | X |
| Comparative | ◯ | X | X | X | X | X | X | X | X | X | X | ◯ | ◯ | ◯ | ◯ |
| Example 1 | | | | | | | | | | | | | | | |
| Comparative | ◯ | X | X | X | X | X | X | X | X | X | ◯ | ◯ | ◯ | ◯ | ◯ |
| Example 2 | | | | | | | | | | | | | | | |
| Comparative | ◯ | X | X | X | X | X | X | X | X | X | X | X | ◯ | ◯ | ◯ |
| Example 3 | | | | | | | | | | | | | | | |
| Comparative | ◯ | X | ◯ | ◯ | ◯ | X | X | X | X | X | X | X | X | X | X |
| Example 4 | | | | | | | | | | | | | | | |
| Comparative | ◯ | X | X | ◯ | ◯ | ◯ | ◯ | X | X | X | X | X | X | X | X |
| Example 5 | | | | | | | | | | | | | | | |
| Comparative | X | X | X | X | X | ◯ | ◯ | ◯ | ◯ | ◯ | ◯ | X | X | X | X |
| Example 6 | | | | | | | | | | | | | | | |

From the result of the aforementioned, using nonionic surfactant of formula (I) independently with the developer prepared from the alkali metal carbonate salt and alkali metal bicarbonate salt, it is apparent that the developing rate is slower than that of developer having oxyethylene nonylphenyl ether, also the concentration of the nonionic surfactant of formula (I) in the developer increases without apparent increase of the developing rate; if using the nonionic surfactant of formula (II) with the developer, the developing rate is too rapid where the photoresist pattern tend to strip off and resulting in a narrower process window that increases the difficulty of production. From the comparative example 6, developer having oxyethylene nonylphenyl ether has poor defoam, where excess amount of foams affect the smoothness of the developing operation.

Regarding to the aforementioned drawbacks, in the examples, both nonionic surfactants of formula (I) and (II) are utilized, and by mixing together the two surfactants in an appropriate ratio, developer with satisfying developing rate and process window is obtained.

Although the present invention has been explained in relation to its preferred embodiments, it is to be understood that many other possible modifications and variations can be made without departing from the scope of the invention as hereinafter claimed.

What is claimed is:

1. A developer composition comprising:
(a) 0.1 to 10 parts by weight of alkali metal carbonate salt, the amount of said alkali metal carbonate salt is calculated with respect to 100 parts by weight of water;
(b) 0.1 to 10 parts by weight of alkali metal bicarbonate salt, the amount of said alkali metal bicarbonate salt is calculated with respect to 100 parts by weight of water;
(c) 0.1 to 20 parts by weight of nonionic surfactant of the following formula (I): 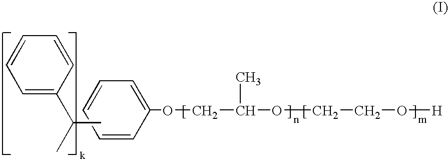
wherein
K is an integer of 1 to 3; n is an integer of 0 to 10; m is an integer of 4 to 20; the parts by weight of the said nonionic surfactant of formula (I) is calculated with respect to 100 parts by weight of water; and
(d) 0.1 to 20 parts by weight of nonionic surfactant of the following formula (II): 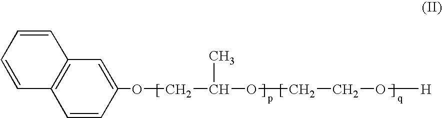
wherein
p is an integer of 0 to 20; q is an integer of 4 to 20; the parts by weight of the said nonionic surfactant of formula (II) is calculated with respect to 100 parts by weight of water.

2. The developer composition of claim 1, wherein n of formula (I) is an integer of 0 to 6; m is an integer of 6 to 15.

3. The developer composition of claim 1, wherein n of formula (I) is 0; m is an integer of 6 to 15.

4. The developer composition of claim 1, wherein p of formula (I) is an integer of 0 to 6; q is an integer of 6 to 15.

5. The developer composition of claim 1, wherein p of formula (II) is 0; q is an integer of 6 to 15.

6. The developer composition of claim 1, wherein said alkali metal carbonate salt is sodium carbonate or potassium carbonate.

7. The developer composition of claim 1, wherein said alkali metal bicarbonate salt is sodium bicarbonate or potassium bicarbonate.

8. The developer composition of claim 1, wherein said developer composition is suitable for the use with photoresists comprising colorants.

9. The developer composition of claim 1, wherein said developer composition is suitable for the use with a photoresist composition comprising an (meth)acrylic polymers.
